(19) United States
(12) Patent Application Publication
(10) Pub. No.: US 2025/0111198 A1
(43) Pub. Date: Apr. 3, 2025

(54) Systems and Methods for Constrained Text Generation Using Large Language Models

(71) Applicant: Salesforce, Inc., San Francisco, CA (US)

(72) Inventors: Lifu TU, San Francisco, CA (US); Semih YAVUZ, Redwood City, CA (US); Yingbo ZHOU, Palo Alto, CA (US)

(21) Appl. No.: 18/422,819

(22) Filed: Jan. 25, 2024

Related U.S. Application Data
(60) Provisional application No. 63/586,319, filed on Sep. 28, 2023.

(51) Int. Cl. G06N 3/0455; G06F 40/284; G06F 40/40; G06N 3/047

(52) U.S. Cl. CPC G06N 3/0455; G06F 40/284; G06F 40/40; G06N 3/047

(57) ABSTRACT

In view of the need to improve text generation technology, embodiments described herein provide a neural network model that generates a text output with constraints to achieve desired output behavior, such as reduced toxicity or hallucinations, and inclusion of certain keywords.

### CROSS REFERENCE(S)

The instant application is a nonprovisional of and claims priority under 35 U.S.C. 119 to U.S. provisional application No. 63/586,319, filed Sep. 28, 2023, which is hereby expressly incorporated by reference herein in its entirety.

### TECHNICAL FIELD

The embodiments relate generally to machine learning systems for text generation, and more specifically to systems and methods for constrained text generation using large language models.

### BACKGROUND

Machine learning systems have been widely used in a number of natural language processing (NLP) tasks, such as question answering, summarization, machine translation, and/or the like. For example, large language models (LLMs) have exhibited a powerful ability for text generation with a given prompt or instruction. However, even with a given instruction that guides the LLM to generate a certain output, LLMs may sometimes generate inaccurate or even non-factual text outputs, referred to as hallucination.

Therefore, there is a need for improved text generation technology with factual accuracy.

### BRIEF DESCRIPTION OF THE DRAWINGS

FIG. 1A is a simplified diagram illustrating a controllable text generation framework, according to embodiments described herein.

FIG. 1B is a simplified diagram illustrating an example of constraint based text generation using the framework described in FIG. 1A, according to some embodiments.

FIG. 2 is a simplified diagram illustrating a computing device implementing the constrained text generation framework described in FIG. 1, according to one embodiment described herein.

FIG. 3 is a simplified diagram illustrating a neural network structure, according to some embodiments.

FIG. 4 is a simplified block diagram of a networked system suitable for implementing the framework described in FIGS. 1-3 and other embodiments described herein.

FIG. 5 is an example logic flow diagram illustrating a method of controllable text generation by a neural network model based on the framework shown in FIGS. 1-4, according to some embodiments.

FIGS. 6A-11 provide example data experiments performance of the constrained text generation framework described in FIGS. 1-5 as compared with various existing text generation models.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters.

LLMs may generate a text output guided by a prompt, e.g., an instruction in the form of a given sequence token, such that the text output sequence is generated conditioned on the prompt and prior output tokens. Output tokens are thus decoded iteratively according to the conditional probability of an output token conditioned on the prompt and previously generated output tokens. However, such generated text output may sometimes contain non-factual information (hallucination), rude, disrespectful or otherwise unreasonable text (toxicity).

In view of the need to improve text generation technology, embodiments described herein provide a decoding mechanism that generates a text output with constraints to achieve desired output behavior. Specifically, an additional constraint term is added to the decoding logits, e.g., the conditional probability of a token given the text input and previously decoded tokens. Thus, the decoder may generate output tokens using the adjusted decoding logits with constraints. The constraint may be designed with different purpose, e.g., to reduce toxicity, to force the output tokens to contain desired keywords, concepts to improve factual correctness, and/or the like. For example, a lexical constraint: “run team field drill” may be translated to a language description constraint as “this will be a sentence with these concepts: run team field drill.”

In this way, with the text constraint, LLM text generation may be controllable by a user for controlling the vocabulary of output text such as desired keywords may be generated in the output. In addition, the constraint may eliminate toxicity and/or hallucination in the output text, e.g., an answer to an input query. Therefore, neural network technology in generative AI is improved.

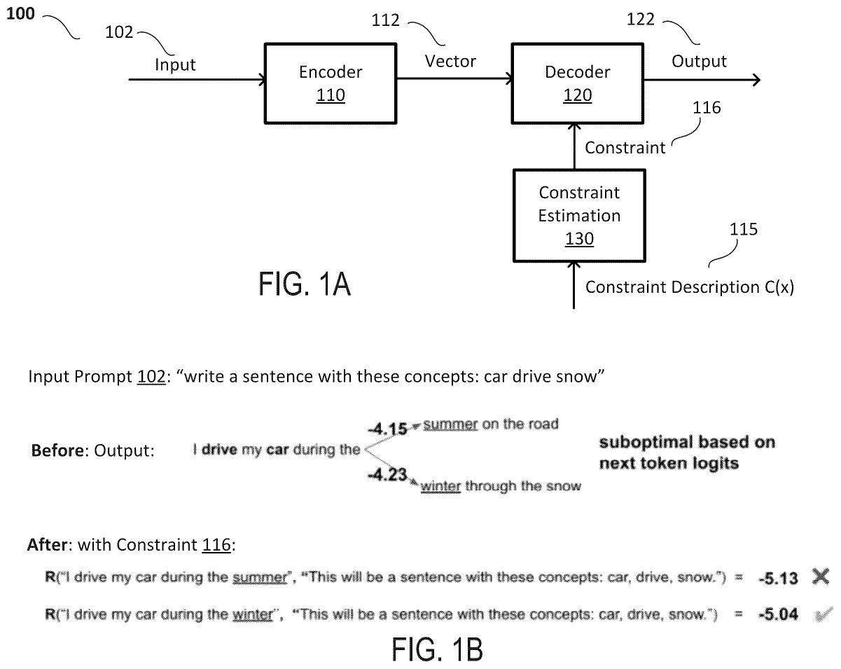

FIG. 1A is a simplified diagram illustrating a controllable text generation framework 100, according to embodiments described herein. The controllable text generation framework 100 comprises an encoder 100, a decoder 120 and a constraint estimation module 130 that jointly transform an input 102 to an output 122. In at least one embodiment the encoder 100 and decoder 120 may belong to a pretrained transformer LLM.

In one embodiment, encoder 110 and decoder 120 may belong to an autoregressive language model. Specifically, given the input 102 that comprises a text prompt, represented as a sequence of tokens x, encoder 110 may first encode the input 102 of tokens into a vector representation 112, and the decoder 120 may subsequently generate an output sequence 122 [symbol] step-by-step, proceeding from left to right:

$$log p ( \vert x ) = {\sum }_{t = 1}^{\vert \vert} log p ( {t}_{} \vert {< t}_{} , x )$$

Here p( [symbol] ₜ| [symbol] _{<t}, x) represents the distribution of the next token at position t given the prompt/prefix x, and the partial output [symbol] <t. Thus, all sequential tokens are iteratively generated based on this conditional probability distribution.

In one embodiment, it is desired that the generated output 122 [symbol] exhibits specific desired behaviors (e.g., reduced toxicity or inclusion of certain keywords). This may be achieved by applying a constraint at the decoder logits in decoder 120. For example, the conditional sequence probability for outputting a token can be derived as follows:

$$\begin{matrix}log p ( ( \vert x ) = {\sum }_{t} log p ( {t}_{} \vert {< t}_{} , x ) ∝ {\sum }_{t} ( p ( {t}_{} \vert {< t}_{} ) * p ( x \vert {<= t}_{} ) ) \\ \approx {\sum }_{t} log ( p ( {t}_{} \vert {< t}_{} , x ) * log p ( C ( x ) \vert {<= t}_{} ) ) \\ \approx {\sum }_{t} ( log ( p ( {t}_{} \vert {< t}_{} , x ) + {\underbrace{R ( {<= t}_{} , C ( x ) ) )}}_{Future constraint}\end{matrix} \qquad ( 1 )$$

where C(x) 115 be a language description (or verbalization) of the constraint. For example, C(x) can be as simple as the input x 102 itself, or in more sophisticated forms to represent desired constraints such as one or more desired keywords to be included in output 122, a description to reduce toxicity by excluding undesired keywords, or to ensure alignment with supported evidence. For example, the task of generating a sentence with keyword constraints: “run team field drill”, C(x) can be verbalized as “This will be a sentence with these concepts: run team field drill.” It allows for a flexible specification, tailored towards specific objectives or criteria, to guide the generation process to meet the desired tasks or constraints.

In one embodiment, the constraint estimation module 130 may compute a constraint term 116 R( [symbol] _{<t}=t₁, C(x)), which may also be referred to as the future constraint satisfaction score, given an output prefix [symbol] (e.g., the previously decoded tokens) and the sequence of token of constraint description C(x) 115. This constraint score 116 may be estimated with any pretrained language model by assessing the likelihood of generating the desired output based on the given constraint.

In one embodiment, such constraints can be broken down into several sub-constraints, each playing a role in measuring distinct constraints to fulfill the overall satisfaction. By aggregating individual future constraint satisfaction scores, the aggregated constraint score 116 may be added to output logits generated at decoder 120 to generate the final output tokens for the output 122.

In one embodiment, for example, the constraint estimation module 130 may compute the future constraint satisfaction score 116 of C(x) using the log-likelihood of generating the constraint conditioned on the prefix [symbol] _{<=t}:

$$R ( {<= t}_{} , C ( x ) ) = \frac{log p ( C ( x ) \vert {<= t}_{} , < SEP > )}{\vert C ( x ) \vert} \qquad ( 2 )$$

where <SEP> is the special token delimiting the two sequences.

In one implementation, the future constraint satisfaction score 116 may be computed by feeding a binary question as input 102, So:

$$R ( {<= t}_{} , C ( x ) ) = log \frac{( p ( Yes \vert prompt )}{{}_{p} ( Yes \vert prompt ) + {}_{p} ( No \vert prompt )}$$

where p(“Yes”|prompt) and p(“No”|“prompt”) are the probabilities of generating “Yes” and “No” as the subsequent token in the output 122, based on the prompt comprising the binary question, respectively.

In one embodiment, the decoder 120 may compute the output conditional probability log p( [symbol] |x) incorporating the constraint score 116 according to Eq. (1). Based on the conditional probability for the next token, the decoder 120 may perform a beam search or nucleus sampling to determine which token to generate following a left-to-right manner. However, these methods may produce suboptimal outputs. In that case, the decoder 120 may proactively account for future costs. Specifically, this following decoding objective may be considered:

$$← arg {max}_{∈} log p ( \vert x ) + λ * R ( , C ( x ) ) \qquad ( 3 )$$

where [symbol] is the set of all sequences and λ is a weight coefficient p( [symbol] |x) denoting the conditional probability distribution by a language model, and R( [symbol] , C(x)) is the estimation satisfaction score for constraint C(x).

The above optimization problem (3) can often be computationally challenging, therefore the beam-based search algorithm may be used to solve it approximately. Considering the current prefix [symbol] _{<t}, a new token [symbol] _{<t} is predicted at each step, and the top k best candidate tokens may be selected using the following criterion:

$$← log p ( {<= t}_{} \vert x ) + λ * R ( {<= t}_{} , C ( x ) ) \qquad ( 4 )$$

where Vₜ is candidate output space at position t, e.g., Vₜ as the top 2*k candidates in cumulative probability mass p( [symbol] _{<t}|x). Additional tokens may be added to this candidate set. For example, in keyword-constrained generation tasks, another token set, V_{keys}, may be introduced, which consists of tokens found in keywords. In this way, these crucial tokens are considered at each decoding step. This process may be iterated until certain conditions are met, such as encountering an end-of-sequence token or reaching the maximum allowed length, etc. The candidate that achieves the highest score according to (4) from the top k candidates may form the final output 122.

FIG. 1B is a simplified diagram illustrating an example of constraint based text generation using the framework described in FIG. 1A, according to some embodiments. The framework 100 shown in FIG. 1B uses a constraint to guide text generation. For example, given an input prompt 102 “write a sentence with these concepts: car drive snow,” traditionally a language model may generate output tokens “I”, “drive,” “my,” “car,” “during,” “the,” “summer” (or “winter”), “on” (or “through”), “the,” “road” (or “snow”) based on an argmax operation based on logits. In some scenarios, the language model may generate inaccurate next token predictions, e.g., tokens following “summer” may have a higher logit than tokens following “winter” and thus lead to an output sequence of “I drive my car during the summer on the road” which deviates from the desired concepts of “car drive snow.”

In one embodiment, with constraint 116 described in FIG. 1A, the decoder logits may be constrained by the constraint description 115 (e.g., “This will be a sentence with these concepts: car, drive, snow”). Thus, the constraint 116 computed based on previously decoded tokens “I drive my car during the summer” and the constraint description 115, e.g., R (“I drive my car during the summer,” “This will be a sentence with these concepts: car, drive, snow”) may yield a lower final logit compared to the logits constrained by R (“I drive my car during the winter,” “This will be a sentence with these concepts: car, drive, snow”). Therefore, by incorporating future constraint satisfaction R(x) 116, “winter” is selected as a more preferrable choice for next token. In this way, the desired concepts “car,” “drive” and “snow” are reinforced and thus incorporated into the final output 122.

### Computer and Network Environment

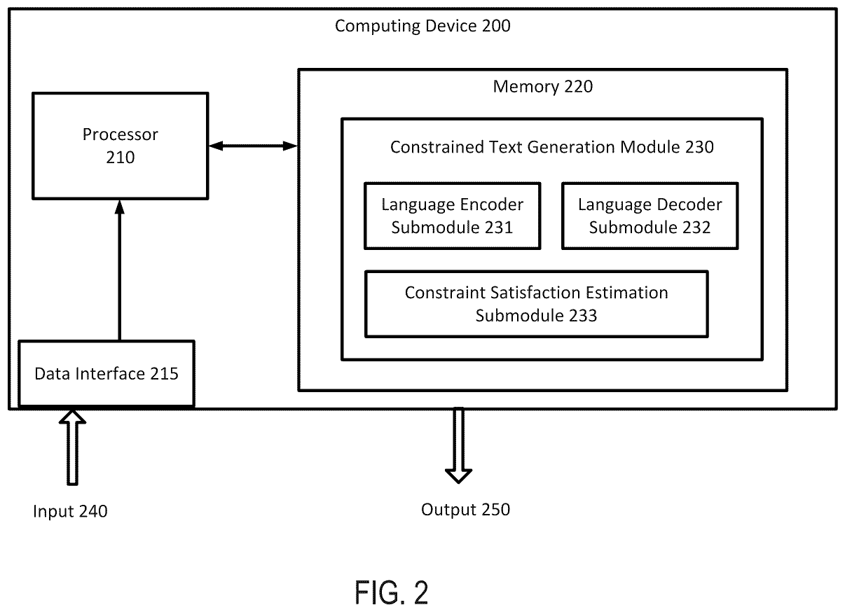

FIG. 2 is a simplified diagram illustrating a computing device implementing the constrained text generation framework described in FIG. 1, according to one embodiment described herein. As shown in FIG. 2A, computing device 200 includes a processor 210 coupled to memory 220. Operation of computing device 200 is controlled by processor 210. And although computing device 200 is shown with only one processor 210, it is understood that processor 210 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 200. Computing device 200 may be implemented as a stand-alone subsystem, as a board added to a computing device, and/or as a virtual machine.

Memory 220 may be used to store software executed by computing device 200 and/or one or more data structures used during operation of computing device 200. Memory 220 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 210 and/or memory 220 may be arranged in any suitable physical arrangement. In some embodiments, processor 210 and/or memory 220 may be implemented on a same board, in a same package (e.g., system-in-package), on a same chip (e.g., system-on-chip), and/or the like. In some embodiments, processor 210 and/or memory 220 may include distributed, virtualized, and/or containerized computing resources. Consistent with such embodiments, processor 210 and/or memory 220 may be located in one or more data centers and/or cloud computing facilities.

In some examples, memory 220 may include non-transitory, tangible, machine readable media that includes executable code that when run by one or more processors (e.g., processor 210) may cause the one or more processors to perform the methods described in further detail herein. For example, as shown, memory 220 includes instructions for constrained text generation module 230 that may be used to implement and/or emulate the systems and models, and/or to implement any of the methods described further herein. Constrained text generation module 230 may receive input 240 such as an input text (e.g., a user question, etc.) via the data interface 215 and generate an output 250 which may be an answer to the input question.

The data interface 215 may comprise a communication interface, a user interface (such as a voice input interface, a graphical user interface, and/or the like). For example, the computing device 200 may receive the input 240 (such as a training dataset) from a networked database via a communication interface. Or the computing device 200 may receive the input 240, such as an input question, from a user via the user interface.

In some embodiments, the constrained text generation module 230 is configured to generate an answer to an input question subject to a constraint as described herein and in Appendix I. The constrained text generation module 230 may further include a language encoder 231, a language decoder 232 and a constraint satisfaction estimation submodule 233. The constraint satisfaction estimation submodule 233 may be configured to estimate a future constraint satisfaction score used for the language decoder 232 to generate an output text as described herein and in Appendix I.

Some examples of computing devices, such as computing device 200 may include non-transitory, tangible, machine readable media that include executable code that when run by one or more processors (e.g., processor 210) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

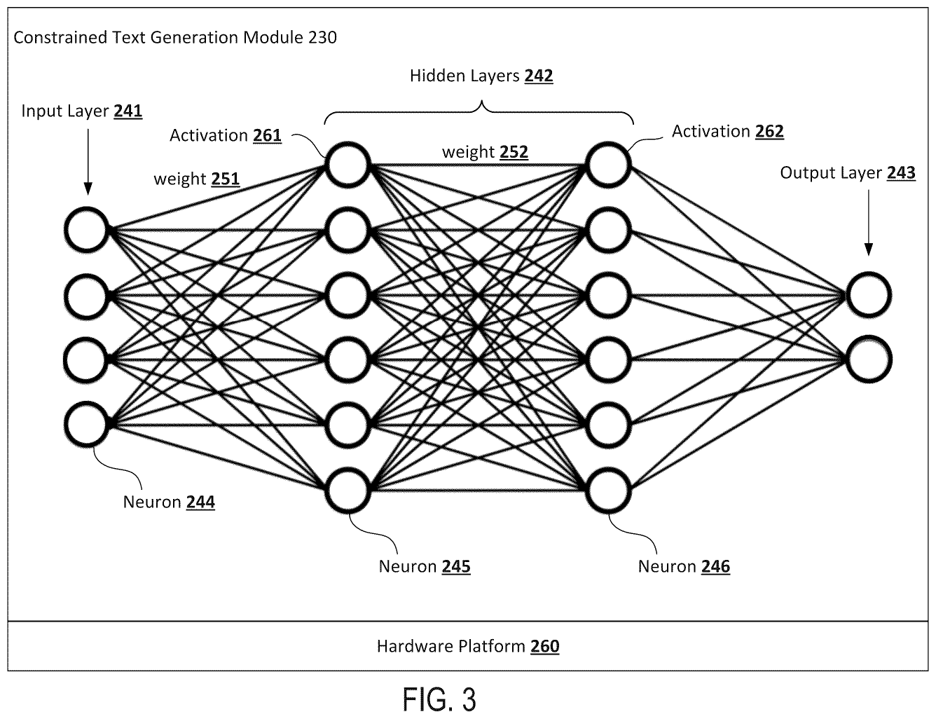

FIG. 3 is a simplified diagram illustrating the neural network structure implementing the constrained text generation module 230 described in FIG. 2, according to some embodiments. In some embodiments, the constrained text generation module 230 and/or one or more of its submodules 231-233 may be implemented at least partially via an artificial neural network structure shown in FIG. 3. The neural network comprises a computing system that is built on a collection of connected units or nodes, referred to as neurons (e.g., 244, 245, 246). Neurons are often connected by edges, and an adjustable weight (e.g., 251, 252) is often associated with the edge. The neurons are often aggregated into layers such that different layers may perform different transformations on the respective input and output transformed input data onto the next layer.

For example, the neural network architecture may comprise an input layer 241, one or more hidden layers 242 and an output layer 243. Each layer may comprise a plurality of neurons, and neurons between layers are interconnected according to a specific topology of the neural network topology. The input layer 241 receives the input data (e.g., 240 in FIG. 2), such as an input question of a sequence of tokens. The number of nodes (neurons) in the input layer 241 may be determined by the dimensionality of the input data (e.g., the length of a vector of the input question). Each node in the input layer represents a feature or attribute of the input.

The hidden layers 242 are intermediate layers between the input and output layers of a neural network. It is noted that two hidden layers 242 are shown in FIG. 2B for illustrative purpose only, and any number of hidden layers may be utilized in a neural network structure. Hidden layers 242 may extract and transform the input data through a series of weighted computations and activation functions.

For example, as discussed in FIG. 2, the constrained text generation module 230 receives an input 240 of an input question and transforms the input into an output 250 of an answer. To perform the transformation, each neuron receives input signals, performs a weighted sum of the inputs according to weights assigned to each connection (e.g., 251, 252), and then applies an activation function (e.g., 261, 262, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 241 is transformed into rather different values indicative data characteristics corresponding to a task that the neural network structure has been designed to perform.

The output layer 243 is the final layer of the neural network structure. It produces the network's output or prediction based on the computations performed in the preceding layers (e.g., 241, 242). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the constrained text generation module 230 and/or one or more of its submodules 231-233 may comprise the transformative neural network structure of layers of neurons, and weights and activation functions describing the non-linear transformation at each neuron. Such a neural network structure is often implemented on one or more hardware processors 210, such as a graphics processing unit (GPU). An example neural network may be GPT, and/or the like.

In one embodiment, the constrained text generation module 230 and its submodules 231 may be implemented by hardware, software and/or a combination thereof. For example, the constrained text generation module 230 and its submodules 231 may comprise a specific neural network structure implemented and run on various hardware platforms 260, such as but not limited to CPUs (central processing units), GPUs (graphics processing units), FPGAs (field-programmable gate arrays), Application-Specific Integrated Circuits (ASICs), dedicated Al accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 260 used to implement the neural network structure is specifically configured based on factors such as the complexity of the neural network, the scale of the tasks (e.g., training time, input data scale, size of training dataset, etc.), and the desired performance.

In one embodiment, the neural network based constrained text generation module 230 and one or more of its submodules 231-233 may be trained by iteratively updating the underlying parameters (e.g., weights 251, 252, etc., bias parameters and/or coefficients in the activation functions 261, 262 associated with neurons) of the neural network based on the loss. For example, during forward propagation, the training data such as question-answer pairs are fed into the neural network. The data flows through the network's layers 241, 242, with each layer performing computations based on its weights, biases, and activation functions until the output layer 243 produces the network's output 250. In some embodiments, output layer 243 produces an intermediate output on which the network's output 250 is based.

The output generated by the output layer 243 is compared to the expected output (e.g., a “ground-truth” such as the corresponding answer to a training question) from the training data, to compute a loss function that measures the discrepancy between the predicted output and the expected output. For example, the loss function may be cross entropy, MMSE, and/or the like. Given the loss, the negative gradient of the loss function is computed with respect to each weight of each layer individually. Such negative gradient is computed one layer at a time, iteratively backward from the last layer 243 to the input layer 241 of the neural network. These gradients quantify the sensitivity of the network's output to changes in the parameters. The chain rule of calculus is applied to efficiently calculate these gradients by propagating the gradients backward from the output layer 243 to the input layer 241.

Parameters of the neural network are updated backwardly from the last layer to the input layer (backpropagating) based on the computed negative gradient using an optimization algorithm to minimize the loss. The backpropagation from the last layer 243 to the input layer 241 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as generating an answer to a new unseen question.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

Therefore, the training process transforms the neural network into an “updated” trained neural network with updated parameters such as weights, activation functions, and biases. The trained neural network thus improves neural network technology in natural language processing, such as in the application of an automatic agent, chatbots, and/or the like.

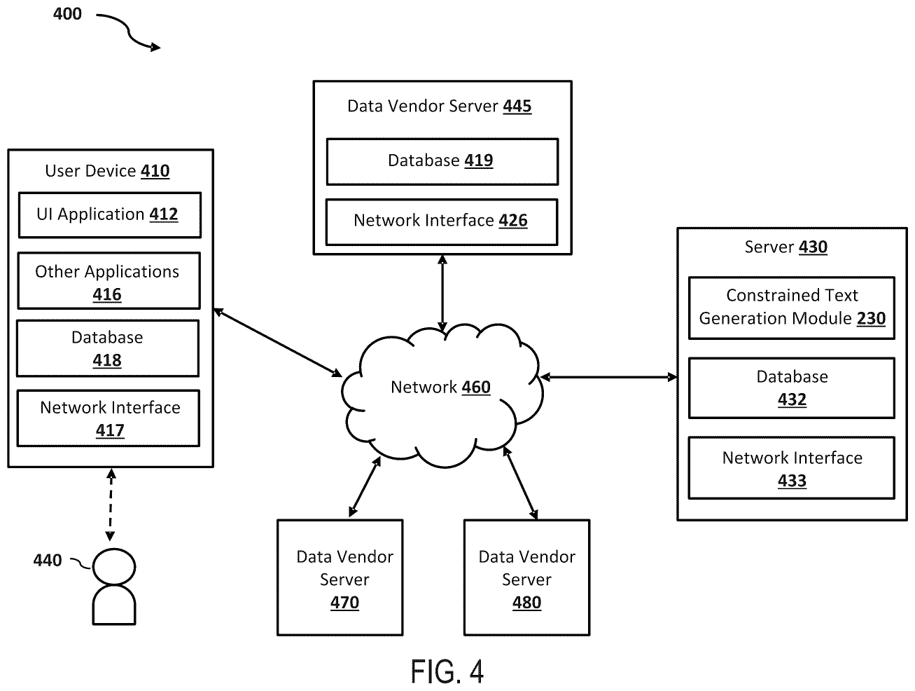

FIG. 4 is a simplified block diagram of a networked system 400 suitable for implementing the constrained text generation framework described in FIGS. 1-3 and other embodiments described herein. In one embodiment, system 400 includes the user device 410 which may be operated by user 440, data vendor servers 445, 470 and 480, server 430, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2A, operating an OS such as a MICROSOFT® OS, a UNIX® OS, a LINUX® OS, or other suitable device and/or server-based OS. It can be appreciated that the devices and/or servers illustrated in FIG. 4 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 410, data vendor servers 445, 470 and 480, and the server 430 may communicate with each other over a network 460. User device 410 may be utilized by a user 440 (e.g., a driver, a system admin, etc.) to access the various features available for user device 410, which may include processes and/or applications associated with the server 430 to receive an output data anomaly report.

User device 410, data vendor server 445, and the server 430 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

User device 410 may be implemented as a communication device that may utilize appropriate hardware and software configured for wired and/or wireless communication with data vendor server 445 and/or the server 430. For example, in one embodiment, user device 410 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 410 of FIG. 4 contains a user interface (UI) application 412, and/or other applications 416, which may correspond to executable processes, procedures, and/or applications with associated hardware. For example, the user device 410 may receive a message indicating a generated text from the server 430 and display the message via the UI application 412. In other embodiments, user device 410 may include additional or different modules having specialized hardware and/or software as required.

In various embodiments, user device 410 includes other applications 416 as may be desired in particular embodiments to provide features to user device 410. For example, other applications 416 may include security applications for implementing client-side security features, programmatic client applications for interfacing with appropriate application programming interfaces (APIs) over network 460, or other types of applications. Other applications 416 may also include communication applications, such as email, texting, voice, social networking, and IM applications that allow a user to send and receive emails, calls, texts, and other notifications through network 460. For example, the other application 416 may be an email or instant messaging application that receives a prediction result message from the server 430. Other applications 416 may include device interfaces and other display modules that may receive input and/or output information. For example, other applications 416 may contain software programs for asset management, executable by a processor, including a graphical user interface (GUI) configured to provide an interface to the user 440 to view the generated text.

User device 410 may further include database 418 stored in a transitory and/or non-transitory memory of user device 410, which may store various applications and data and be utilized during execution of various modules of user device 410. Database 418 may store user profile relating to the user 440, predictions previously viewed or saved by the user 440, historical data received from the server 430, and/or the like. In some embodiments, database 418 may be local to user device 410. However, in other embodiments, database 418 may be external to user device 410 and accessible by user device 410, including cloud storage systems and/or databases that are accessible over network 460.

User device 410 includes at least one network interface component 417 adapted to communicate with data vendor server 445 and/or the server 430. In various embodiments, network interface component 417 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 445 may correspond to a server that hosts database 419 to provide training datasets including NLP datasets to the server 430. The database 419 may be implemented by one or more relational database, distributed databases, cloud databases, and/or the like.

The data vendor server 445 includes at least one network interface component 426 adapted to communicate with user device 410 and/or the server 430. In various embodiments, network interface component 426 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 445 may send asset information from the database 419, via the network interface 426, to the server 430.

The server 430 may be housed with the constrained text generation module 230 and its submodules described in FIG. 2A. In some implementations, constrained text generation module 230 may receive data from database 419 at the data vendor server 445 via the network 460 to generate a text output. The generated text output may also be sent to the user device 410 for review by the user 440 via the network 460.

The database 432 may be stored in a transitory and/or non-transitory memory of the server 430. In one implementation, the database 432 may store data obtained from the data vendor server 445. In one implementation, the database 432 may store parameters of the constrained text generation module 230. In one implementation, the database 432 may store previously generated outputs, and the corresponding input feature vectors.

In some embodiments, database 432 may be local to the server 430. However, in other embodiments, database 432 may be external to the server 430 and accessible by the server 430, including cloud storage systems and/or databases that are accessible over network 460.

The server 430 includes at least one network interface component 433 adapted to communicate with user device 410 and/or data vendor servers 445, 470 or 480 over network 460. In various embodiments, network interface component 433 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 460 may be implemented as a single network or a combination of multiple networks. For example, in various embodiments, network 460 may include the Internet or one or more intranets, landline networks, wireless networks, and/or other appropriate types of networks. Thus, network 460 may correspond to small scale communication networks, such as a private or local area network, or a larger scale network, such as a wide area network or the Internet, accessible by the various components of system 400.

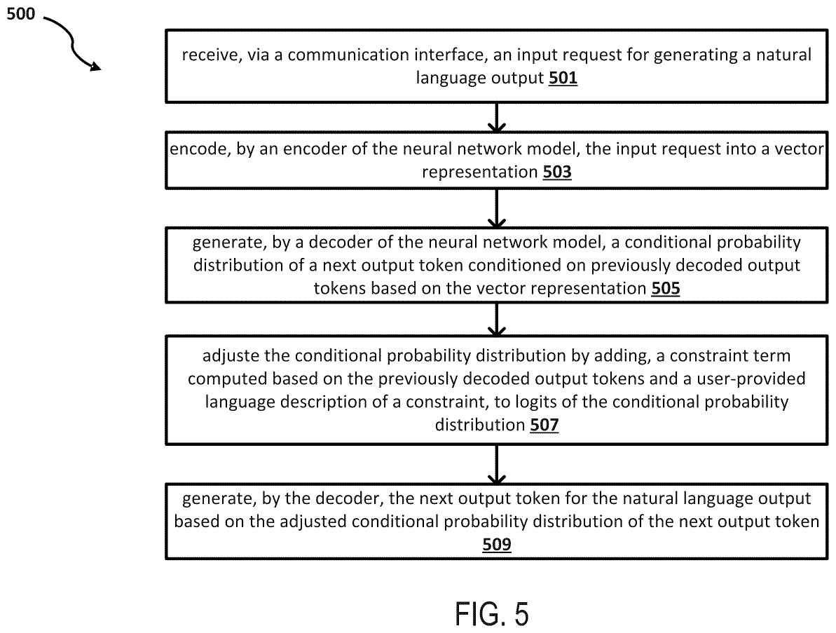

FIG. 5 is an example logic flow diagram illustrating a method 500 of controllable text generation by a neural network model based on the framework shown in FIGS. 1-4, according to some embodiments. One or more of the processes of method 500 may be implemented, at least in part, in the form of executable code stored on non-transitory, tangible, machine-readable media that when run by one or more processors may cause the one or more processors to perform one or more of the processes. In some embodiments, method 700 corresponds to the operation of the constrained text generation module 230 (e.g., FIGS. 2 and 4) that generates an output subject to a constraint.

As illustrated, the method 500 includes a number of enumerated steps, but aspects of the method 500 may include additional steps before, after, and in between the enumerated steps. In some aspects, one or more of the enumerated steps may be omitted or performed in a different order.

At step 501, constrained text generation module 230 may receive, via a communication interface (e.g., data interface 215 in FIG. 2, or network interface 433 in FIG. 4), an input request (e.g., input 102 in FIG. 1A) for generating a natural language output at a neural network model. For example, the neural network model is a pretrained large language model, and the natural language output is generated for a variety of natural language processing (NPL) tasks without finetuning the pretrained large language model. In one implementation, the neural network model may be located remotely and accessible by an application programming interface (API).

At step 503, an encoder (e.g., 110 in FIG. 1A, 231 in FIG. 2) of the neural network model may encode the input request into a vector representation (e.g., 112 in FIG. 1A).

At step 505, a decoder (e.g., 120 in FIG. 1A, 232 in FIG. 2) of the neural network

model may generate a conditional probability distribution of a next output token conditioned on previously decoded output tokens based on the vector representation.

At step 507, the conditional probability distribution may be adjusted, by adding, a constraint term (e.g., R(x) 116 in FIG. 1) computed based on the previously decoded output tokens and a user-provided language description (e.g., C(x) 115 in FIG. 1) of a constraint, to logits of the conditional probability distribution. For example, the constraint term is computed as a logit of a conditional probability for the decoder to output the user-provided language description conditioned on the previously decoded tokens, divided by a length of the user-provided language description. For another example, the user-provided language description of the constraint comprises a sequence of tokens in the input request. For another example, the user-provided language description of the constraint comprises one or more of: an indication of one or more desired keywords to be used in the natural language output, and an indication of one or more undesired keywords not to be included in the natural language output.

In another implementation, the user-provided language description of the constraint comprises one or more of: one or more retrieved documents relevant to the input request; and one or more distilled concepts relevant to the input request.

At step 509, the decoder may generate the next output token for the natural language output (e.g., 122 in FIG. 1) based on the adjusted conditional probability distribution of the next output token. For example, the decoder may select a number K of top candidate tokens from a candidate set based on the adjusted conditional probability distribution at a first decoding step, and the candidate set comprises one or more desired keywords.

### Example Data Experiments

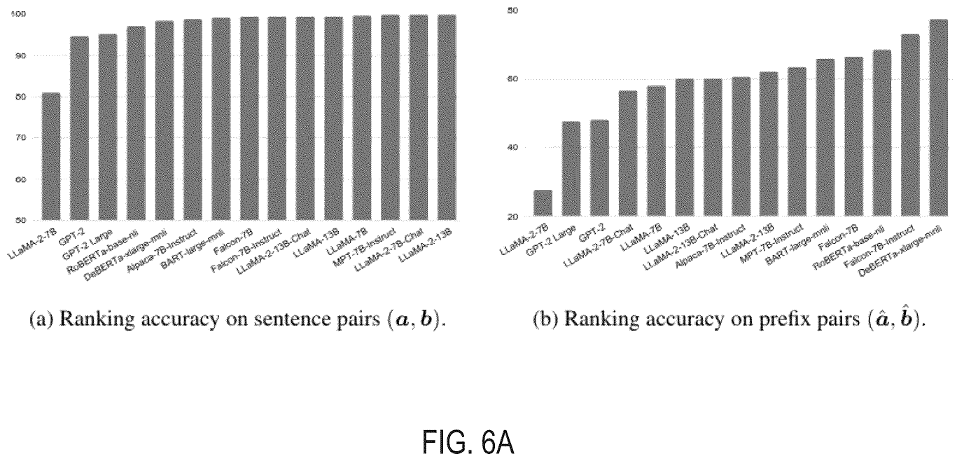

FIGS. 6A-11 provide example data experiments performance of the constrained text generation framework described in FIGS. 1-5 as compared with various existing text generation models. For example, the performance of the proposed method is tested on three different tasks: keyword-constrained generation, toxicity reduction, and factual correctness in question-answering.

In one embodiment, lexical-constrained text generation is performed using the CommonGen dataset, which involves generating a sentence containing specific given key words. For instance, given a set of concepts (e.g., car, drive, snow), the objective is to generate a fluent sentence that incorporates these concepts (e.g., “I drive my car during the winter through the snow”). The generated outputs are evaluated using automatic metrics of fluency (BLEU, CIDER, etc.) and a constraint coverage score. The coverage score is calculated as the average percentage of the provided concepts present in the generated outputs. In order to check the estimation quality of future constraint satisfaction using LLMs, a ranking benchmark, where each sample consists of a sentence pair (a, b), with a being the sentence with a constraint C and b without. Each a is derived from the development set of CommonGen, while b is a complete sentence generated by ChatGPT given a few prefix words from a. If this completed sentence b does not include all the specified concepts, it should be treated as a negative sample compared to a.

In one embodiment, a distinct scenario involving a sequence pair (â, \hat{b}) is considered, where both sequences have similar lengths and are incomplete. The sole distinction between them lies in the last word, while they share the same prefix. â and \hat{b} have the same prefix, except for the last word. Specifically, â is the prefix of â, and \hat{b} has the same prefix as a, except for the last word. The last word in b is a randomly selected word from b. For each sentence pair (â, \hat{b}), a ranking accuracy score of 1 is assigned if R(a, C)>R(b, C). Otherwise, the ranking accuracy score is 0. FIG. 6A shows the ranking accuracies of keyword-constrained satisfaction estimation using various models. High accuracies over sentence pairs are observed. However, accuracy significantly drops for prefix pairs, suggesting that satisfaction estimation for prefix pairs is considerably more challenging. Fortunately, many open LLMs still manage to achieve over 60% accuracy. Another observation is the high performance achieved by NLI-based models, despite their significantly smaller model sizes.

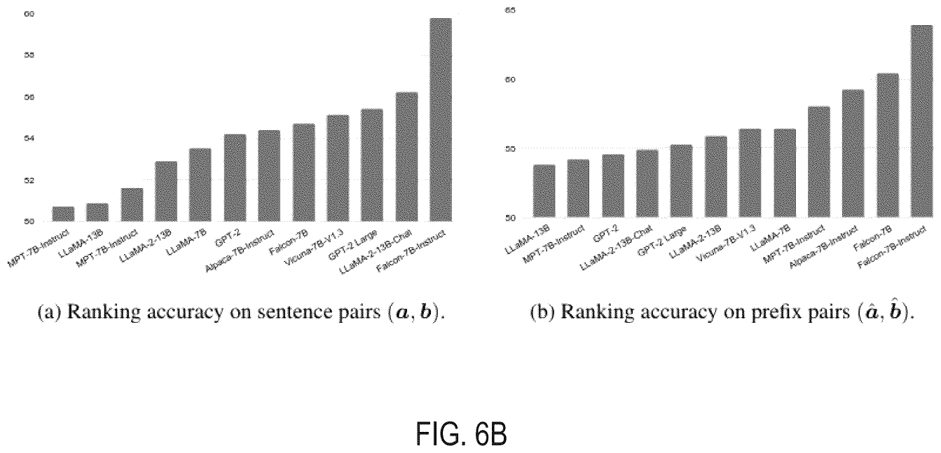

FIG. 7 displays the constraint coverage of sentences (every right column) and BLEU-4 scores (every left column) on the CommonGen development set. λ=0 corresponds to a decoding method without considering future constraint satisfaction. For λ in the range λ∈{1, 2, . . . , 10} (x-axis), the constrained text generation method consistently achieves higher coverage scores, indicating a higher percentage of provided concepts present in the generated outputs. However, setting a very large λ can excessively weigh on the constraint satisfaction term and hurt performance.

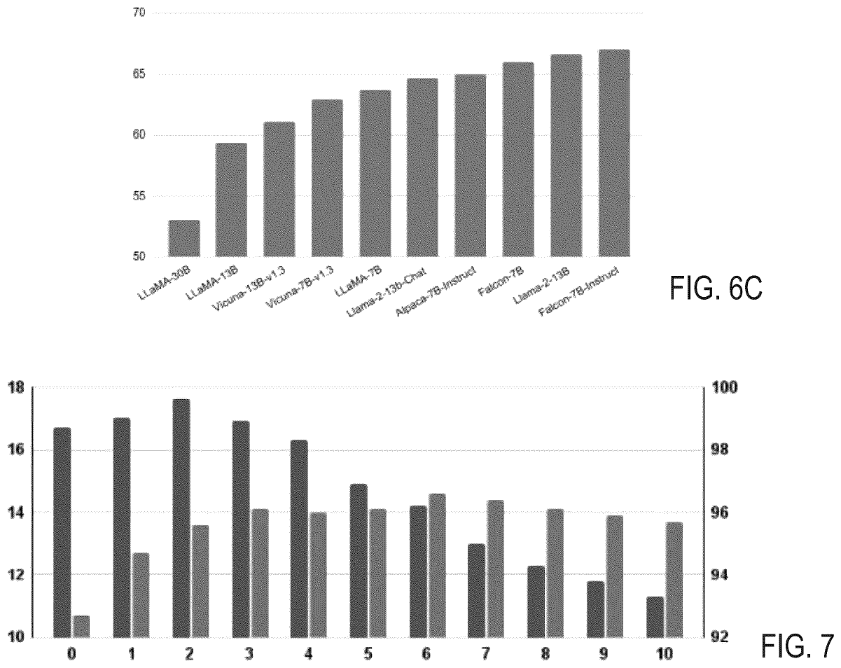

With the select hyperparameter λ on the development set, FIG. 8 presents the results for several selected LLMs. Notably, it is observed that high-quality outputs from these instruction-tuned models (Falcon-7B-Instruct, LLAMA-2-13B-Chat, Falcon-40B-Instruct). Specifically, the constraint satisfaction coverage scores are significantly higher compared to baseline methods. Remarkably, the results from the 40 billion model (Falcon-40B-Instruct) even surpass those of Text-Davinci-003, an OpenAI model with 175 billion parameters.

For the task of toxicity reduction, given a prompt x, the task is to generate a fluent continuation [symbol] but not with a toxicity attribute. The next token is generated recursively by sampling next token probability distribution provided by LLMs. In one embodiment, up to 20 tokens with nucleus sampling ( [symbol] =0.9) are generated. Generation toxicity may be measured using the toxicity score from Perspective API. Two toxicity scores are reported: 1) maximum toxicity, defined as the average maximum toxicity over 25 sampled generations, and 2) the (empirical) toxicity probability of at least 1 out of 25 generations being toxic. The generations for fluency, and diversity are also evaluated. Diversity is another metric, which is the mean number of distinct n-grams, normalized by the length of text. Specifically, the constraint text generation method reweight the top k=50 token logits from LLMs with the future constraint satisfaction score, then truncate the logits that are in the top-k/top-p vocabulary at each position, effectively assigning zero probability to tokens outside the vocabulary. The hyperparameter λ may be set by evaluating its performance on a set of 50 samples.

To evaluate the quality of toxicity constraint scores from LLMs, ranking benchmark may be set as: constructing sequence pairs (a, b) where a is less toxic than b, a file containing numerous model outputs and human-evaluated toxicity scores. From the given file, sequence pairs (a, b) are created by employing the same prompt prefix and pairing it with two distinct annotated continuations, each having its own toxicity score. The prefix pair (a, b) is formed using the common prefix and the first word from these two continuations. For a given prompt x, the description of the toxicity constraint C(x)=“This will be a rude, disrespectful, or unreasonable comment.” A ranking accuracy score of 1 is assigned if R(a, C(x))>R(b, C(x)), otherwise 0. FIG. 6B shows the ranking accuracy of various LLMs on the aforementioned toxicity ranking benchmark. Many open LLMs demonstrate an accuracy surpassing 50%, which represents the performance of random guessing. Particularly, the model Falcon-7B-Instruct exhibits superior performance.

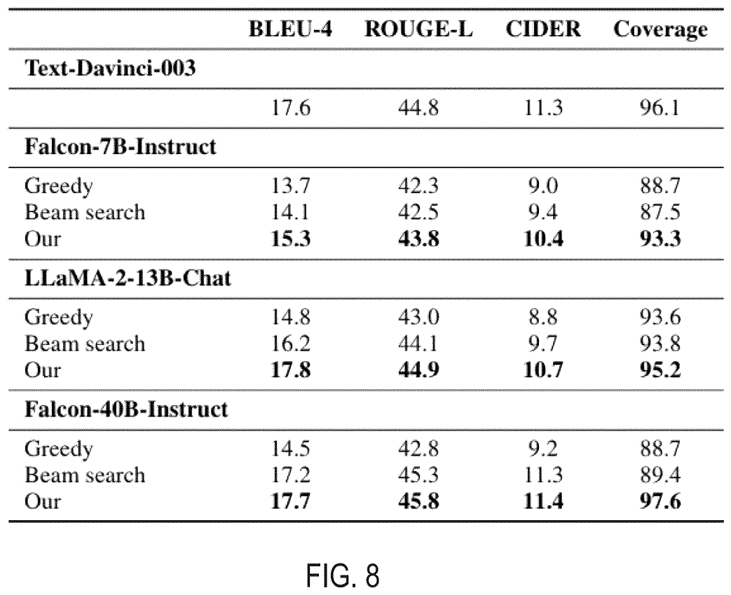

FIG. 9 presents the toxicity reduction on two different LLMs (Falcon-7B-Instruct and Alpaca-7B-Instruct), which also have a minor decrease on diversity.

For the task of factual generation, the dateset ALCE is used as a factual question answering. This benchmark provides a set of retrieved passages, denoted as D={D1, D2, . . . }, for each question q. Additionally, the dataset offers correctness evaluation through multiple short answers in ASQA (described in Stelmakh et al., ASQA: Factoid questions meet long-form answers, in Proceedings of the 2022 conference on empirical methods in natural language processing, pp. 8273-8288, 2022) and three “sub-claims” for ELI5 (Fan et al., ELI5: Long form question answering, in Proceedings of the 57^{th} Annual Meeting of the Association for Computational Linguistics, 2019). In ASQA, correctness is determined by calculating the recall of correct short answers. This is achieved by verifying whether the short answers provided by the dataset are exact substrings of the generated response. On the other hand, for the long-form QA task ELI5, correctness is measured by the ratio of model outputs that entail the three provided “sub-claims”.

In one embodiment, 2-shot may be evaluated on the above dataset, and three retrieved documents are used each question. In the future satisfaction score term R( [symbol] _{<=t}, C(x)) can be the retrieved document or sub-claims. The hyperparameter λ may be set by evaluating its performance on a set of a few samples. Two different deterministic search-based methods: greedy decoding and beam search with beam size=5 are used as baselines for comparison. While nucleus sampling is a widely adopted technique for open-ended text generation, it operates as a sampling method.

In one embodiment, factual correctness ranking benchmark is constructed using the fact verification part of TRUE (Honovich et al., TRUE: Re-evaluating factual consistency evaluation, in Proceedings of the 2022 Conference of the North American Chapter of the Association for Computational Linguistics, pp. 3905-3920, 2022). Specifically, we focused on FEVER (Thorne et al., the fact extraction and VERification (FEVER) shared task, in proceedings of the first workshop on Fact Extraction and VERification (FEVER), pp. 1-9, 2018) and VitaminC (Schuster et al., Get your vitamin C! robust fact verification with contrastive evidence, in Proceedings of the 2021 Conference of the North American Chapter of the Association for Computational Linguistics, pp. 624.643, 2021) within the TRUE dataset. In the training set of FEVER and VitaminC, for each evidence (as C), one claim is chosen denoted as a that was supported by the evidence, and another claim that was not supported by the evidence, denoted as b. This formed pairs of sentences: (a, b). For each evidence, if the factual constraint estimation score is higher for the supported claim com-pared to the unsupported claim with respect to the evidence, an accuracy score of 1 is assigned. Otherwise, if R(a, evidence)≤R(b, evidence), the accuracy score is 0. FIG. 6C displays the accuracies on our constructed factual correctness ranking benchmark. It is observed that several open LLMs achieve more than 60% accuracy.

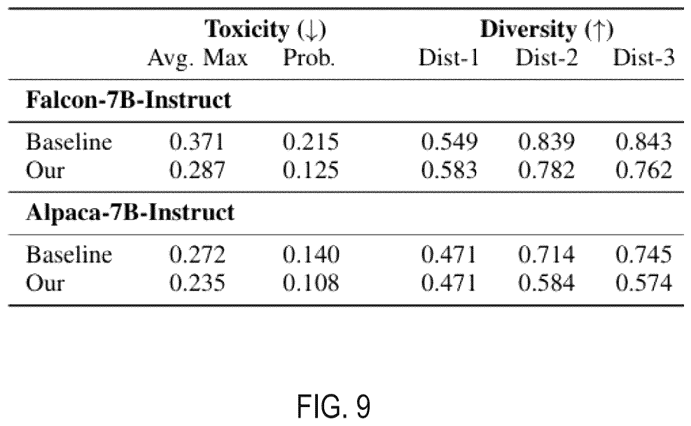

In one embodiment, several samples for which the retrieved documents support the answers are considered. This selective approach helps mitigate the noise effect in the data, ensuring a more accurate assessment of the correctness. FIG. 10 shows the results on question answer tasks. In general, it is observed that beam search tends to perform comparably to greedy decoding on factual correctness. The constrained text generation method demonstrates a significant enhancement in factual correctness compared to the baselines for both tasks.

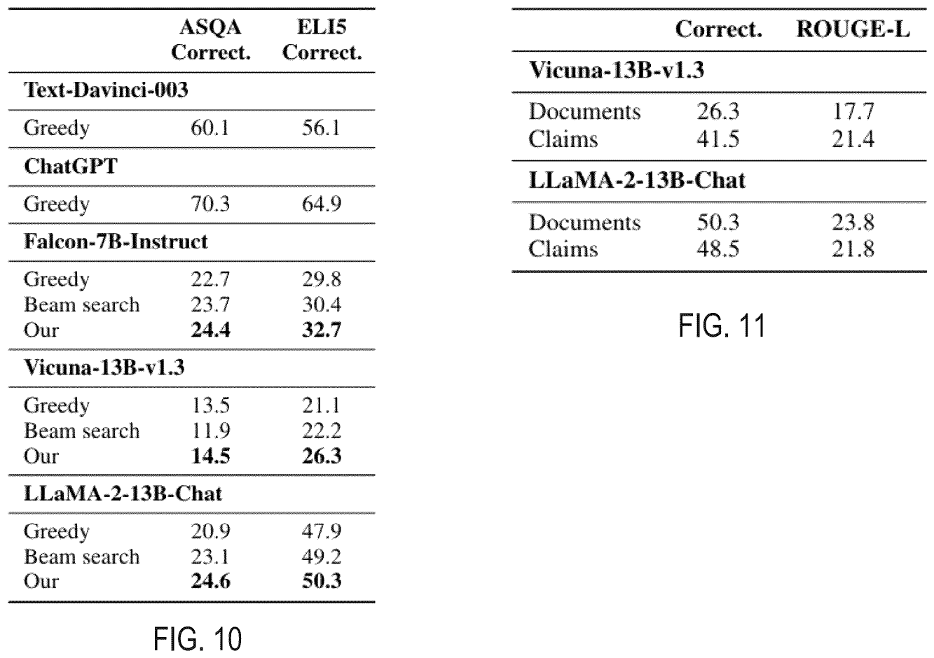

In FIG. 10 we present the results for the case where the constraint C(x) corresponds to the retrieved documents. Furthermore, FIG. 11 displays the results when the constraint is “sub-claims.” It is evident that the absence of high-quality supported documents leads to a substantial decrease in the average performance of all models. Therefore, the constraint text generation method improves output accuracy even if accurate and credible supporting documents may not be available in question-answering tasks.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method for controllable text generation by a neural network model, the method comprising:
receiving, via a communication interface, an input request for generating a natural language output;
encoding, by an encoder of the neural network model, the input request into a vector representation;
generating, by a decoder of the neural network model, a conditional probability distribution of a next output token conditioned on previously decoded output tokens based on the vector representation;
adjusting the conditional probability distribution by adding, a constraint term computed based on the previously decoded output tokens and a user-provided language description of a constraint, to logits of the conditional probability distribution;
generating, by the decoder, the next output token for the natural language output based on the adjusted conditional probability distribution of the next output token.

2. The method of claim 1, wherein the constraint term is computed as a logit of a conditional probability for the decoder to output the user-provided language description conditioned on the previously decoded tokens, divided by a length of the user-provided language description.

3. The method of claim 1, wherein the user-provided language description of the constraint comprise a sequence of tokens in the input request.

4. The method of claim 1, wherein the user-provided language description of the constraint comprises one or more of:
an indication of one or more desired keywords to be used in the natural language output; and
an indication of one or more undesired keywords not to be included in the natural language output.

5. The method of claim 1, wherein the user-provided language description of the constraint comprises one or more of:
one or more retrieved documents relevant to the input request; and
one or more distilled concepts relevant to the input request.

6. The method of claim 1, wherein the generating, by the decoder, the next output token comprises:
selecting a number of top candidate tokens from a candidate set based on the adjusted conditional probability distribution at a first decoding step,
wherein the candidate set comprises one or more desired keywords.

7. The method of claim 1, wherein the neural network model is a pretrained large language model, and wherein the natural language output is generated for a variety of natural language processing (NPL) tasks without finetuning the pretrained large language model.

8. A system for controllable text generation by a neural network model, the system comprising:
a communication interface that is configured to receive an input request for generating a natural language output;
a memory storing an encoder and a decoder of the neural network model, and a plurality of processor-executable instructions; and
one or more processors to execute the plurality of processor-executable instructions to perform operations comprising:
encoding, by the encoder, the input request into a vector representation;
generating, by the decoder, a conditional probability distribution of a next output token conditioned on previously decoded output tokens based on the vector representation;
adjusting the conditional probability distribution by adding, a constraint term computed based on the previously decoded output tokens and a user-provided language description of a constraint, to logits of the conditional probability distribution;
generating, by the decoder, the next output token for the natural language output based on the adjusted conditional probability distribution of the next output token.

9. The system of claim 8, wherein the constraint term is computed as a logit of a conditional probability for the decoder to output the user-provided language description conditioned on the previously decoded tokens, divided by a length of the user-provided language description.

10. The system of claim 8, wherein the user-provided language description of the constraint comprise a sequence of tokens in the input request.

11. The system of claim 8, wherein the user-provided language description of the constraint comprises one or more of:
an indication of one or more desired keywords to be used in the natural language output; and
an indication of one or more undesired keywords not to be included in the natural language output.

12. The system of claim 8, wherein the user-provided language description of the constraint comprises one or more of:
one or more retrieved documents relevant to the input request; and
one or more distilled concepts relevant to the input request.

13. The system of claim 8, wherein the operation of generating, by the decoder, the next output token comprises:
selecting a number of top candidate tokens from a candidate set based on the adjusted conditional probability distribution at a first decoding step,
wherein the candidate set comprises one or more desired keywords.

14. The system of claim 8, wherein the neural network model is a pretrained large language model, and wherein the natural language output is generated for a variety of natural language processing (NPL) tasks without finetuning the pretrained large language model.

15. A non-transitory processor-readable storage medium for storing a plurality of processor-readable instructions for controllable text generation by a neural network model, the processor-readable instructions being executed by one or more processors to perform operations comprising:
receiving, via a communication interface, an input request for generating a natural language output;
encoding, by an encoder of the neural network model, the input request into a vector representation;
generating, by a decoder of the neural network model, a conditional probability distribution of a next output token conditioned on previously decoded output tokens based on the vector representation;
adjusting the conditional probability distribution by adding, a constraint term computed based on the previously decoded output tokens and a user-provided language description of a constraint, to logits of the conditional probability distribution;
generating, by the decoder, the next output token for the natural language output based on the adjusted conditional probability distribution of the next output token.

16. The medium of claim 15, wherein the constraint term is computed as a logit of a conditional probability for the decoder to output the user-provided language description conditioned on the previously decoded tokens, divided by a length of the user-provided language description.

17. The medium of claim 15, wherein the user-provided language description of the constraint comprise a sequence of tokens in the input request.

18. The medium of claim 15, wherein the user-provided language description of the constraint comprises one or more of:
an indication of one or more desired keywords to be used in the natural language output; and
an indication of one or more undesired keywords not to be included in the natural language output.

19. The medium of claim 15, wherein the user-provided language description of the constraint comprises one or more of:
one or more retrieved documents relevant to the input request; and
one or more distilled concepts relevant to the input request.

20. The medium of claim 15, wherein the operation of generating, by the decoder, the next output token comprises:
selecting a number of top candidate tokens from a candidate set based on the adjusted conditional probability distribution at a first decoding step,
wherein the candidate set comprises one or more desired keywords.
